(19) United States
(12) Patent Application Publication
(10) Pub. No.: US 2010/0240418 A1
(43) Pub. Date: Sep. 23, 2010

(54) Automated light control system

(75) Inventor: Chiaki Matoba, Osaka (JP)

Correspondence Address: HARNESS, DICKEY & PIERCE, P.L.C., P.O. BOX 8910, RESTON, VA, 20195, US

(73) Assignee: SHARP KABUSHIKI KAISHA

(21) Appl. No.: 12/659,555

(22) Filed: Mar. 12, 2010

(30) Foreign Application Priority Data
Mar. 23, 2009 (JP) 2009-069324

(51) Int. Cl. G09G 3/36; H04M 1/00

(52) U.S. Cl. 455/566; 345/207; 345/102

(57) ABSTRACT

An automated light control system for controlling light emission from the backlight of the liquid crystal display in such a manner that the power consumption can be reduced, taking the information on the brightness in the peripheral region and the information on the distance into total consideration, is provided. The automated light control system is characterized in that a brightness information detecting means for detecting the brightness in the periphery and outputting information on the brightness for indicating the brightness and a distance information detecting means for outputting information on the distance for indicating the distance between the liquid crystal display and the user are provided, and the amount of light emitted by the light illumination means (backlight) is controlled on the basis of both the above described information on the brightness and the above described information on the distance.

### CROSS REFERENCE TO RELATED APPLICATION

This Nonprovisional application claims priority under 35 U.S.C. §119(a) on Patent Application No. 2009-069324 filed in Japan on 23 Mar., 2009 the entire contents of which are hereby incorporated by reference.

### BACKGROUND OF THE INVENTION

1. Field of the Invention

The present invention relates to an automated light control system for adjusting the amount of light from a light illumination means in a video apparatus having a display means with the light illumination means for illuminating light of which the amount corresponds to a control current.

2. Description of the Related Art

In general liquid crystal devices used in a video apparatus, such as a cellular phone, the liquid crystal panel for display is illuminated with light from the rear by means of a backlight using a light source, such as LEDs (light emitting diodes). In these liquid crystal devices, however, the power consumption when the backlight is used is relatively large, which greatly affects the time for driving the battery of a portable video apparatus, and therefore, reduction in the power consumption when the backlight is used is an issue.

With regards to the technology for controlling the backlight of the liquid crystal display, Japanese Unexamined Patent Publication 2003-215534 discloses an automated light control system for adjusting the amount of light emitted by a backlight in accordance with the amount of light in the periphery of a liquid crystal display that is detected by a light receiving element, for example. In the case where the peripheral region is relatively bright, for example, the amount of light emitted by the backlight is reduced, while in the case where the peripheral region is relatively dark, the amount of light emitted by the backlight is increased, and thus, maintenance of the quality of the display for a video signal and reduction of the power consumption are achieved.

In addition, Japanese Unexamined Patent Publication 2001-4978 discloses a system for reducing the power consumption through an intermittent operation of a light receiving element in addition to an automated light control system for detecting the amount of light in the periphery of a liquid crystal display by means of a light receiving element and adjusting the amount of light emitted by the backlight.

In addition, with regards to a technology for controlling the backlight of the liquid crystal display, Japanese Unexamined Patent Publication H6 (1994)-282231 discloses the configuration where the power consumption is reduced in sync with the fluorescent lamp in addition to the automated light control.

In the automated light control systems in the Japanese Unexamined Patent Publication 2003-215534 or the Japanese Unexamined Patent Publication 2001-4978, though the power consumption is reduced by controlling the amount of light emitted by the backlight in accordance with the amount of light in the periphery of the liquid crystal display, it is not taken into consideration whether or not the user of the liquid crystal display is looking at the liquid crystal display, and furthermore, for what purpose the user is looking at the liquid crystal display (manner of use).

As described above, the power source is limited in the portable video apparatus that is battery operated, and therefore, it is required to reduce the power consumption, while in the automated light control systems in the Japanese Unexamined Patent Publication 2003-215534 or the Japanese Unexamined Patent Publication 2001-4978, light is adjusted irrelevant of whether or not the user is looking at the liquid crystal display.

### SUMMARY OF THE INVENTION

The present invention is provided in view of the above described problems, and an object of the invention is to provide an automated light control system where the power consumption can be reduced by controlling the amount of light emitted by the backlight or turning off the light emission in accordance with the information from a proximity sensor while reducing the power consumption, taking the brightness in the peripheral region and the brightness required for viewing the displayed video into total consideration.

The automated light control system according to the present invention is firstly characterized by being provided with, in a video apparatus having a display means with a light illumination means, a distance information detecting means for detecting the distance between the video apparatus and a user thereof and outputting information on the distance between the video apparatus and the user, a brightness detecting means for detecting the brightness in a predetermined region in the periphery and outputting information on the brightness in the predetermined region, and a light emission control means for controlling the amount of light emitted by the light illumination means on the basis of both the information on the brightness and the information on the distance.

Furthermore, in addition to the above described first characteristic, the automated light control system according to the present invention is secondly characterized in that the light emission control means controls the amount of light emitted by the light illumination means step by step.

Moreover, in addition to the above described first characteristic, the automated light control system according to the present invention is thirdly characterized in that the light emission control means stops light emission from the light illumination means on the basis of the information on the distance.

Furthermore, in addition to the above described third characteristic, the automated light control system according to the present invention is fourthly characterized in that the light emission control means resumes light emission from the light illumination means on the basis of the information on the distance.

Furthermore, in addition to the above described fourth characteristic, the automated light control system according to the present invention is fifthly characterized in that the control condition of the information on the distance for stopping the light emission from the light illumination means and the control condition of the information on the distance for resuming the light emission from the light illumination means are different.

Moreover, in addition to any of the above described first to fifth characteristics, the automated light control system according to the present invention is sixthly characterized in that the control conditions of the information on the brightness and the information on the distance for the light emission control means to control the amount of light emitted from the light illumination means are stored in an information converting table.

Furthermore, in addition to any of the above described first to sixth characteristics, the automated light control system according to the present invention is seventhly characterized in that the display means is a liquid crystal display for a cellular phone and the light emission control means controls the light illumination means on the basis of the information on the distance in such a manner that light emission is stopped or resumed when the cellular phone is used in telephone call.

Moreover, in addition to any of the above described first to sixth characteristics, the automated light control system according to the present invention is eighthly characterized in that the display means is a liquid crystal display for a cellular phone and the light emission control means controls the amount of light emitted from the light illumination means on the basis of both the information on the brightness and the information on the distance when the cellular phone is not used in telephone call.

Furthermore, in addition to the above described eighth characteristic, the automated light control system according to the present invention is ninthly characterized in that the light emission control means controls the amount of light emitted by the light illumination means on the basis of the information on the brightness, the information on the distance and the manner of use of the cellular phone by the user when the cellular phone is not used in telephone call.

In the automated light control system characterized as described above, the light emission control means makes it possible to adjust the amount of light emitted by the light illumination means (backlight) on the basis of the information indicated by the information on the brightness and the information on the distance. That is to say, in addition to automated light control where the amount of light emitted by the backlight is increased in the case where the amount of light in the periphery is relatively high, while the amount of light emitted by the backlight is reduced in the case where the amount of light is relatively low, the power consumption can be reduced by lowering the amount of emitted light on the basis of the information on the distance between the system and the user.

Furthermore, the relationship between the amount of light emitted by the backlight that is controlled and the above described information on the brightness and information on the distance is stored in the information converting table so that the automated light control system characterized as described above can be formed as hardware. As a result, the amount of light emitted by the backlight can be adjusted without a CPU (central processing unit), and therefore, the amount of operation by the CPU can be reduced, and the power consumption by the CPU can be reduced.

Moreover, turning ON/OFF of the light emission from the backlight is controlled on the basis of the information on the distance in addition to the automated light control for adjusting the amount of light emitted by the backlight on the basis of the information on the brightness and the information on the distance, and thus, the power consumption can be reduced. At this time, the information on the distance for turning OFF the light emission from the backlight and the information on the distance for turning ON the light emission are different, and hysteresis control is carried out so that chattering due to turning ON/OFF the backlight can be prevented, and thus, automated light control becomes possible without the user of the video apparatus feeling discomfort.

Accordingly, the present invention can provide an automated light control system where the power consumption can be reduced by adjusting the amount of light emitted by the backlight or turning OFF the light emission of the backlight taking the information on the brightness in the peripheral region and the information on the distance from the proximity sensor into total consideration.

### BRIEF DESCRIPTION OF THE DRAWINGS

FIG. 1 is a diagram showing the system configuration of the automated light control system according to the present invention;

FIG. 2 is a graph showing an example of setting of the relationship between the information on the brightness and the LED control current IF;

FIG. 3 is a graph showing an example of the operation for adjusting light in the automated light control system according to the present invention; and

FIG. 4 is a diagram showing the transition of states illustrating a light control method for the backlight in the case where the automated light control system according to the present invention is provided in a cellular phone.

### DESCRIPTION OF THE PREFERRED EMBODIMENTS

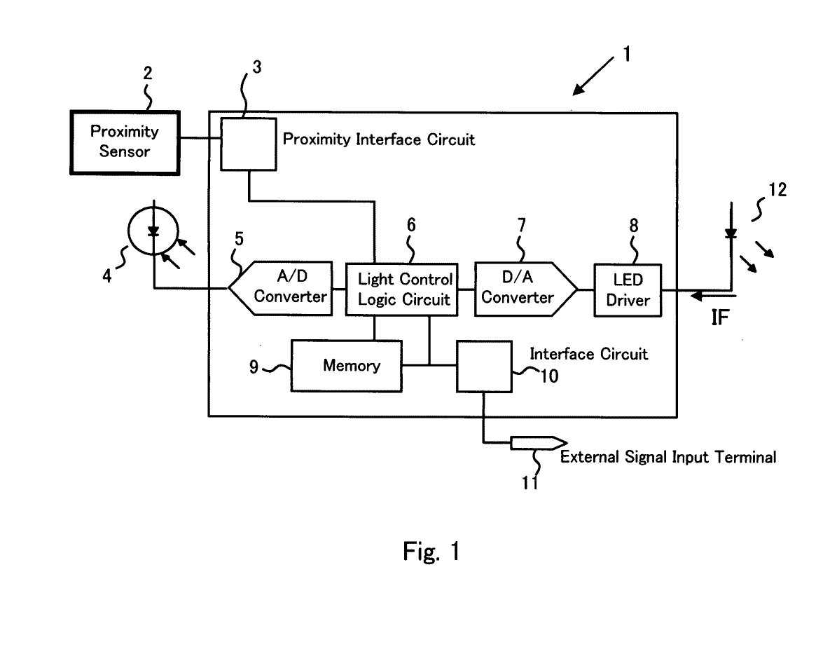

FIG. 1 is a diagram showing the configuration of the automated light control system according to one embodiment of the present invention (hereinafter referred to as “system 1 of the present invention”). Here, though a case where the system 1 of the present invention is used in a semi-transmission type liquid crystal display that is provided in a cellular phone, which is an example of a portable video apparatus, and controls the backlight, which is a light illumination means, is described in the present embodiment, the invention is not limited to this. The invention can be used for controlling the backlight of transmission type liquid crystal displays and the front light or the side light of reflection type liquid crystal displays.

As shown in FIG. 1, the system 1 of the present invention is provided with a proximity sensor 2, a proximity interface circuit 3 for receiving an output signal from the proximity sensor 2 and outputting information on the distance, an illumination sensor 4, an A/D converter 5 for converting an output signal from the illumination sensor 4 to information on the brightness, a light control logic circuit 6, a D/A converter 7, an LED driver circuit 8 for controlling an LED control current IF for the backlight which illuminates from the rear with light, a memory 9 and an interface circuit 10, and can set the amount of light emitted by the backlight of an LED 12 on the basis of the information on the brightness from the illumination sensor 4 and the information on the distance from the proximity sensor 2 when the backlight is about to be turned ON so that turning ON/OFF of the light emission can be set.

The proximity sensor 2 detects the distance between the video apparatus and the user. Here, general proximity sensors are sensors for detecting an object to be detected without making contact, and there is a system where light is outputted from a light emitting diode and the reflected light is received by a light receiving sensor. There are other systems where an eddy current generated in a metal body through electromagnetic induction is used, a change in the capacitance is detected when a body to be detected approaches, and a magnet is used. Here, a system is used where infrared rays emitted by a light emitting diode and then reflected are received. As for the output signal from the proximity sensor 2, a signal at a low or high level is outputted with a certain distance being a threshold value. The proximity interface circuit 3 receives an output signal from the proximity sensor 2 and outputs the information on the distance to the light control logic circuit 6 as a digital signal. Here, a proximity sensor having hysteresis may be used in the case where hysteresis is controlled in accordance with the distance.

Here, in the case where the output from the proximity sensor 2 is a current of which the amount is proportional to the distance, the proximity interface circuit 3 converts the amount of current outputted from the proximity sensor 2 to a digital value so that the information on the distance can be outputted to the light control logic circuit 6 as a digital signal.

The illumination sensor 4 is installed in the proximity of the liquid crystal panel and detects the brightness in a predetermined region in the periphery. Here, a region at a distance of approximately 50 cm from the sensor is assumed to be the predetermined region in the periphery, for example, and the illumination (1×) can be detected from the amount of light that enters into the sensor under the assumption that the illumination sensor 4 is close to the user relative to the light source (within approximately 50 cm from the user). Though the illumination sensor 4 is formed of a photo diode for converting the incident light to a current signal, the invention is not limited to this. The illumination sensor 4 can be formed of another light receiving element for outputting a current signal having a current value in accordance with the intensity of the incident light, for example.

The A/D converter 5 converts a current signal outputted from the illumination sensor 4 to a digital signal indicating information on the brightness and outputs a signal for information on the brightness indicating the brightness in the predetermined region to the light control logic circuit 6. The illumination sensor 4 and the A/D converter 5 form a means for detecting information on the brightness. In the present embodiment, the illumination sensor 4 and the A/D converter 5 are in one chip which outputs a signal for information on the brightness as digital information.

The light control logic circuit 6 sets the amount of light emitted by the backlight in the liquid crystal display by reading out the value in the information conversion table stored in the memory 9 on the basis of the information on the distance outputted from the proximity interface circuit 3 and the information on the brightness outputted from the A/D converter 5, so that the higher the brightness indicated by the information on the brightness is, the greater the amount of light emission is, and the larger the distance information indicated by the information on the distance is, the greater the amount of light emission is, and outputs the digital value corresponding to the set amount of light emitted by the backlight to the D/A converter 7. The D/A converter 7 converts the digital value to an analog signal corresponding to the amount of current for controlling the backlight of the LED 12 and sends the analog signal to the LED driver 8. The LED driver circuit 8 adjusts the LED control current IF for the backlight on the basis of the analog signal. As a result, the amount of light emitted from the backlight of the LED 12 is controlled step by step on the basis of the information on the brightness from the illumination sensor 4 and the information on the distance from the proximity sensor 2.

The memory 9 is formed of a volatile register or a nonvolatile memory, such as a flash memory, for example, and stores a two-dimensional information conversion table which prescribes the relationship between the value of the LED control current IF and the information on the brightness and information on the distance. The information conversion table is set so that the higher the brightness indicated by the information on the brightness is, the greater the value of the control current is, and the greater the distance from the user indicated by the information on the distance is, the greater the value of the control current is, and the value of the control current is set so as to be linear for increase and decrease of the brightness indicated by the information on the brightness and the distance from the user indicated by the information on the distance. However the invention is not limited to this. Proximity along a polynominal curve is also possible using an information conversion table.

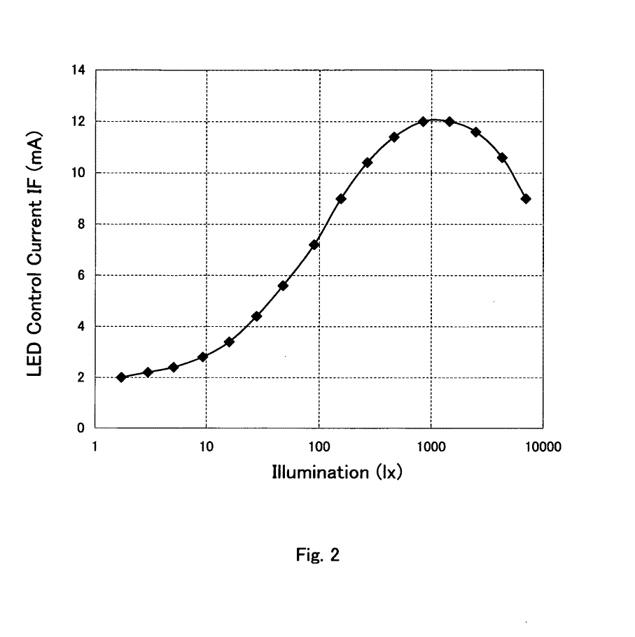

FIG. 2 shows an example of the setting of the relationship between the LED control current IF and the information on the brightness stored in the information conversion table in the case where a semi-transmission type liquid crystal display is used as a display for a video apparatus. In FIG. 2, in the case where the surroundings are relatively dark (1000 lux or less), the brighter the surroundings are, the higher the LED control current IF is, while in the case where the surroundings are bright and sufficient external light can be secured, the brighter the surroundings are, the lower the LED control current IF is.

The interface circuit 10 is formed so as to receive a setting signal for setting the information conversion table from the external signal input terminal 11 and make it possible to update the information conversion table stored in the memory 9 on the basis of this setting signal.

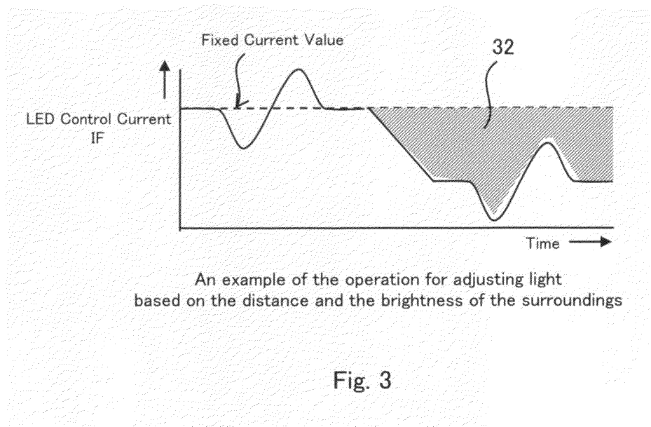

It is possible for the above described system 1 of the present invention to adjust the amount of light emitted by the backlight taking both the information on the brightness and the information on the distance into consideration, and as shown in FIG. 3, when compared to the case where it can be assumed that the amount of light emitted by the backlight is constant according to the prior art, it becomes possible to cut down the power consumption by the amount of current corresponding to the hatched portion 32 in FIG. 3.

Furthermore, the above described system 1 of the present invention is not under direct control of the CPU because the light control logic circuit 6 controls the backlight on the basis of the information conversion table, and thus the CPU operates less, and at the same time, the power consumption by the CPU is also low.

In addition, the above described system 1 of the present invention can carry out such control that the light emission by the backlight stops when the distance from the user becomes smaller and light emission resumes when the distance becomes greater, and thus, the backlight can be turned ON/OFF on the basis of the information on the distance between the video apparatus and the user, for example, so that it becomes possible to further reduce the power consumption. Alternatively, the configuration may allow the backlight to be turned OFF in accordance with the distance from the user (5 cm or less, for example) only in the case where reduction of power consumption is prioritized, for example in the case where the remaining power of the battery of the video apparatus is low or the power conservation mode is set. Particularly in the case where the system 1 of the present invention is used in a cellular phone, the backlight can be turned OFF in accordance with the distance from the user while the phone is used in telephone call, and thus, it becomes possible to greatly reduce the power consumption. The system 1 of the present invention makes it possible to control the backlight in accordance with the brightness of the surroundings and the distance from the user, and can control the backlight in accordance with the manner in which the user is using the video apparatus, in addition to cases where the conditions for the apparatus, for example the condition of the battery, are used for control.

Here, as concerns the manner in which the user is using the video apparatus and the conditions for the apparatus, for example the state of the battery, the light control logic circuit 6 receives an update signal from the CPU of the video apparatus when the manner of use or the conditions for the apparatus change, and thus, the control mode for the backlight may change on the basis of the information on the brightness and the information on the distance.

Furthermore, in the case where the backlight is controlled so as to be turned ON/OFF on the basis of the information on the distance, hysteresis control is desirable, with the information on the distance for turning OFF the light emission of the backlight and the information on the distance for turning ON the light emission being different. The backlight can be switched from ON to OFF when the distance from the user is 5 cm or less, while the backlight can be switched from OFF to ON when the distance from the user is 15 cm or more. As a result, chattering can be prevented, due to the turning ON/OFF of the backlight, and thus, automated light control becomes possible without the user of the video apparatus feeling uncomfortable.

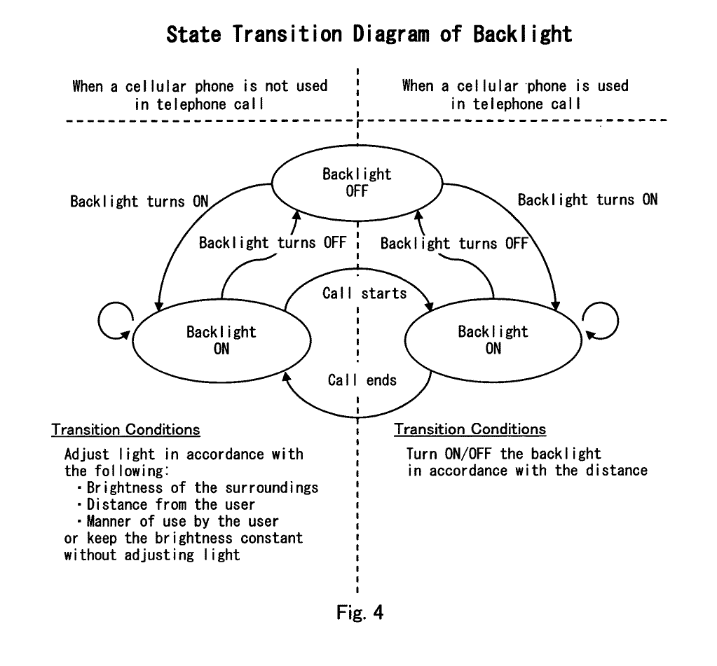

FIG. 4 is a diagram showing the transition of states illustrating an example of a control method when the above described system 1 of the present invention is used for the control of the backlight for the liquid crystal display in a cellular phone. As shown in FIG. 4, the method for controlling the backlight may be changed on the basis of whether or not the phone is used in telephone call.

While the phone is used in telephone call, the backlight can be controlled so as to be turned ON/OFF in accordance with the distance from the user, and thus, the power consumption of the backlight can be made 0 while the phone is used in telephone call, and it becomes possible to greatly reduce the power. Furthermore, when the backlight is turned OFF, there is no control over the amount of light emission on the basis of the information on the brightness from the illumination sensor 4, and therefore, the illumination sensor 4 is turned OFF and the power consumption of the A/D converter 5, the D/A converter 7, the LED driver circuit 8 and the memory 9 can be kept to the minimum, and thus, the power can be reduced by the amount required for the process of automated light control.

Alternatively, only in the case where reduction of the power consumption is prioritized, for example when the remaining power of the battery for the cellular phone is low, or the power conservation mode is set, the configuration allows the backlight to be turned OFF on the basis of the distance.

When the phone is not used in telephone call, the light is automatically adjusted on the basis of the information on the brightness and the information on the distance, so that the amount of light emitted by the backlight can be controlled, and thus, the power consumption can be reduced. At this time, light is automatically adjusted by controlling the required amount of light emission on the basis of the conditions for the apparatus, for example the state of the battery, and the manner in which the user is using the cellular phone (replying to an e-mail, using the internet, viewing one-segment TV or the like), in addition to the information on the brightness and the information on the distance, and thus, it is possible to further reduce the power consumption. When the manner in which the user is using the cellular phone and the conditions for the apparatus, for example the state of the battery, change, the light control circuit 6 receives an update signal from the CPU of the cellular phone, and thus, the control mode for the backlight can be updated on the basis of the information on the brightness of the backlight and the information on the distance.

Though in the above described embodiment, the system 1 of the present invention is applied to a liquid crystal display which is mounted in a cellular phone as an example of a video apparatus, the invention is not limited to this. The invention may be applied to liquid crystal displays mounted in other video apparatuses, such as digital cameras, for example. The system 1 of the present invention can control the light illumination means on the basis of the distance from the user and the brightness of the surroundings, and allows for selection of the control mode on the basis of the manner in which the user is using the video apparatus for which the system 1 to the present invention is applied and the conditions for the video apparatus.

Here, the above described embodiment is an example of a preferred embodiment of the present invention. The embodiments of the present invention are not limited to this, and various modifications are possible within such a scope as not to deviate from the gist of the present invention.

The present invention can be used particularly for portable apparatuses having an LED driver with a means for adjusting the amount of light emitted by a light illumination means, such as cellular phones and digital cameras.

Although the present invention has been described in terms of the preferred embodiment, it will be appreciated that various modifications and alternations might be made by those skilled in the art without departing from the spirit and scope of the invention. The invention should therefore be measured in terms of the claims which follow.

What is claimed is:

1. An automated light control system provided in a video apparatus having a display means with a light illumination means, the automated light control system comprising:
a distance information detecting means for detecting a distance between the video apparatus and a user thereof and outputting information on the distance between the video apparatus and the user;
a brightness detecting means for detecting brightness in a predetermined region in a periphery and outputting information on the brightness in the predetermined region; and
a light emission control means for controlling an amount of light emitted by the light illumination means based on both the information on the brightness and the information on the distance.

2. The automated light control system according to claim 1, wherein
the light emission control means controls the amount of light emitted by the light illumination means step by step.

3. The automated light control system according to claim 1, wherein
the light emission control means stops light emission from the light illumination means based on the information on the distance.

4. The automated light control system according to claim 3, wherein
the light emission control means resumes light emission from the light illumination means based on the information on the distance.

5. The automated light control system according to claim 4, wherein
a control condition of the information on the distance for stopping the light emission from the light illumination means and a control condition of the information on the distance for resuming the light emission from the light illumination means are different.

6. The automated light control system according to claim 1, wherein
control conditions of the information on the brightness and the information on the distance for the light emission control means to control the amount of light emitted from the light illumination means are stored in an information converting table.

7. The automated light control system according to claim 1, wherein
the display means is a liquid crystal display for a cellular phone and the light emission control means controls the light illumination means based on the information on the distance in such a manner that light emission is stopped or resumed when the cellular phone is used in telephone call.

8. The automated light control system according to claim 1, wherein
the display means is a liquid crystal display for a cellular phone and the light emission control means controls the amount of light emitted from the light illumination means based on both the information on the brightness and the information on the distance when the cellular phone is not used in telephone call.

9. The automated light control system according to claim 8, wherein
the light emission control means controls the amount of light emitted by the light illumination means based on the information on the brightness, the information on the distance and a manner of use of the cellular phone by the user when the cellular phone is not used in telephone call.
